(19) United States
(12) Patent Application Publication
(10) Pub. No.: US 2023/0122764 A1
(43) Pub. Date: Apr. 20, 2023

(54) Secure Package Delivery

(71) Applicant: Tarang Deshpande, Rancho Mirage, CA (US)

(72) Inventor: Tarang Deshpande, Rancho Mirage, CA (US)

(21) Appl. No.: 17/504,948

(22) Filed: Oct. 19, 2021

(51) Int. Cl. G06Q 10/08

(52) U.S. Cl. CPC G06Q 10/0836

(57) ABSTRACT

In one embodiment, the present disclosure implements a method for determining whether an attempt to access a receptacle associated with a user is authorized. The method includes receiving a request to access the receptacle and identifying a tracking number associated with a package being delivered. Then, the method identifies a carrier associated with the identified tracking number. A network service may then be accessed to determine whether the carrier associated with the identified tracking number is scheduled to deliver the package to the user. If a determination is made that the carrier is scheduled to deliver the package to the user, carrier personnel are provided with access to the receptacle so that the user's delivery may be securely deposited.

### CROSS-REFERENCE TO RELATED APPLICATION

This application claims the benefit of U.S. Provisional Application No. 63/093,345, entitled “SECURE PACKAGE DELIVERY” filed Oct. 19, 2020 which is hereby incorporated by reference in its' entirety.

### BACKGROUND

Electronic Commerce (“eCommerce”) where users initiate purchases over computer networks such as the Internet is experiencing explosive growth. With the Coronavirus pandemic and other societal factors, this growth is likely to continue and may even accelerate. People are becoming more comfortable making purchases online and taking delivery directly at their home or workplace. In addition, considerable cost savings can be achieved by delivering directly to consumers without necessarily requiring “brick-and-mortar” retail establishments. All of these factors are resulting in a rise in eCommerce which is increasing the prevalence of direct-to-consumer deliveries. Accordingly, multiple carriers have implemented a substantial transportation infrastructure for the purpose of making direct delivery to consumers. However, with an ever-increasing number of deliveries, another emerging trend is that of package theft. The problem is sufficiently wide-spread that the term “porch piracy” has been coined to describe having delivered packages stolen. In 2017, surveys revealed that eleven (11) million homeowners reported having an unattended package stolen from their home. Without effective countermeasures, the problem of “porch piracy” will only continue to grow in scope.

A number of systems have heretofore been proposed to serve as a countermeasure to the problem of porch piracy. Each of these systems suffer from drawbacks that have prevented their widespread adoption. One particular drawback of these systems is an inability to provide a cost-effective way to secure a delivery potentially made by any one of a number of different carriers (USPS, Amazon.com, UPS, FedEx, and the like). These systems lack an effective method of authenticating the specific carrier that is scheduled to complete a delivery to a home or business.

### SUMMARY

This Summary is provided to introduce a selection of concepts in a simplified form that are further described below in the Description. This Summary is not intended to identify key features or essential features of the claimed subject matter, nor is the Summary to be used as an aid in determining the scope of the claimed subject matter.

In one embodiment, the present disclosure implements a method for determining whether an attempt to access a receptacle associated with a user is authorized. The method includes receiving a request to access the receptacle and identifying a tracking number associated with a package being delivered. Then, the method may identify a carrier associated with the identified tracking number. A network service may then be accessed to determine whether the carrier associated with the identified tracking number is scheduled to deliver the package to the user. If a determination is made that the carrier is scheduled to deliver the package to the user, carrier personnel are provided with access to the receptacle so that the user's delivery may be securely deposited.

### DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIGS. 1A-B are block diagrams depicting an exemplary point-of-access receptacle where described embodiments of the disclosed subject matter can be implemented;

FIGS. 2A-B are block diagrams depicting an exemplary multi-user receptacle where described embodiments of the disclosed subject matter can be implemented;

FIG. 3 is a block diagram illustrating the components of a computing module configured to perform functions in accordance with the present disclosure;

FIG. 4 is a pictorial depiction of an exemplary networking environment in which aspects of the present disclosure may be implemented; and

FIG. 5 is a pictorial depiction of an exemplary flow diagram operable to authenticate the delivery of a package in accordance with embodiments of the present disclosure.

### DESCRIPTION

The description set forth below is intended as a description of various embodiments of the disclosed subject matter and is not intended to represent the only embodiments. Each embodiment described herein is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

This invention relates to the delivery of a package with secure computer-controlled access to carrier personnel in delivering a package to an address associated with a user or purchaser. In one aspect, the present disclosure provides a secure point-of-access receptacle that enables packages to be securely delivered to a home or business. Receipt and delivery does not require the presence of the intended recipient or anyone else. Instead, carrier personnel utilize a point-of-access receptacle provided by the present disclosure. In this regard, carrier personnel may utilize the receptacle to scan a barcode or other type of tracking code of a package being delivered. With the received tracking code information, a network connection may be utilized to access a network service provided by the present disclosure. The network service performs a comparison between the delivery information associated with the scanned package and the user's scheduled deliveries. In performing this comparison, a determination is made regarding whether someone accessing the point-of-access receptacle is making a bona-fide delivery to a particular user. If a bona-fide delivery is being made, then carrier personnel are granted access to the point-of-access receptacle where the package may be deposited and secured. If otherwise, access to the receptacle is not granted. As a result, potential thieves are prevented from accessing any packages once delivered. However, carrier personnel are able to gain access to the receptacle in instances when a delivery is authorized.

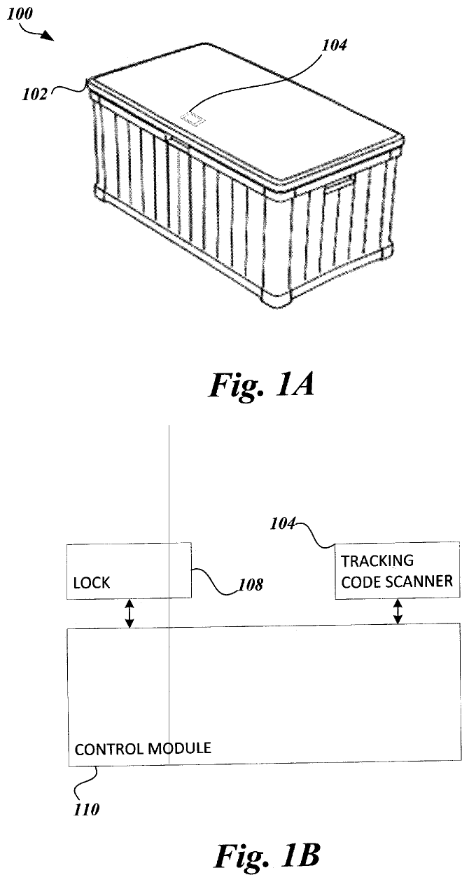

Now with reference to FIGS. 1A-B, a point-of-access receptacle 100 in accordance with one embodiment of the present disclosure will be described. In general, the receptacle 100 depicted in FIG. 1A provides a system for the secure delivery of packages and other items to a potentially unattended location which is simple, yet convenient and secure. The receptacle 100 may be fixed to a home or any other type of building. In this regard, the receptacle 100 would normally be anchored to the porch wall or floor to prevent removal. The receptacle 100 may include a lock 108 (FIG. 1B) that secures a hinged door 102 which is typically secured in the closed position. As further shown in FIG. 1A, the receptacle 100 includes a tracking code scanner 104 which is accessible from the exterior of the receptacle 100. In this regard, the tracking code scanner 104 is configured to scan a tracking code from a package being delivered and derive package identifying information such as a tracking number. By way of example and not limitation, the tracking code may include but is not limited to a bar code, a QR code, or any other type of tracking code suitable for identifying a specific package. As described in further detail below, the information obtained when a package is scanned is used to determine whether an attempt to access the receptacle is authorized.

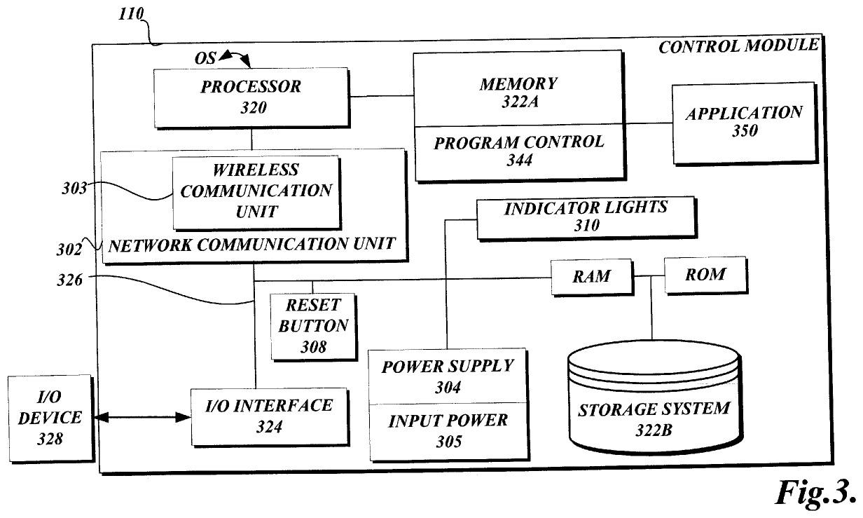

Now with reference to FIG. 1B, a general block diagram of the components used to govern access to the receptacle 100 (FIG. 1A) will be described in further detail. As mentioned above, the point-of-access receptacle 100 includes a lock 108 for securing the hinged door 102 with a latching mechanism (not shown). As illustrated in FIG. 1B, the receptacle 100 further includes a control module 110 that is communicatively connected to both the lock 108 and the tracking code scanner 104. Generally described, the control module 110 is responsible for determining whether an attempt to access the receptacle 100 is authorized. Package information is communicated from the tracking code scanner 104 to the control module 110. In turn, the control module 110 is configured to access a network service and determine whether the package associated with the scanned tracking code is an authorized delivery. The components of the control module 110 and related functionality will be described in further detail below with reference to FIG. 3. However, if a determination is made that the package delivery is authorized, then the control module 110 causes the lock 108 to change to the open position. Once an authorized package has been deposited in the receptacle 100 and the hinged door 102 is closed, the control module 110 again activates and causes the lock 108 to change back to the closed position, thereby securing the hinged door 102 from unauthorized entry.

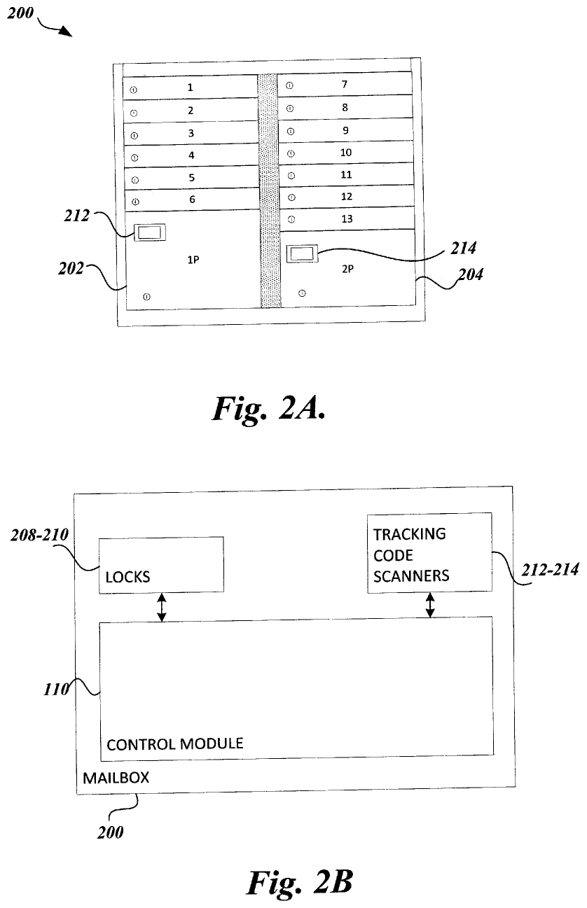

Now with reference to FIGS. 2A-B, additional embodiment of the present invention where packages are secured for potentially multiple users from a common mailbox 200 will be described. The embodiment illustrated and described with reference to FIGS. 2A-B may be implemented to secure packages in multi-family dwellings or office buildings in which a plurality of people share a common mailbox 200. In the embodiment depicted in FIG. 2A, the common mailbox 200 includes the point-of-access receptacles 202 and 204 which include many of the same components described above with reference to FIGS. 1A-B including the locks 208-210 that each secures a hinged door which is typically maintained in the closed position. As further shown in FIG. 2A, the receptacles 202-204 each include a tracking code scanner 212-214 which are each accessible from the exterior of the receptacles 202-204.

As shown in FIG. 2B, the common mailbox 200 further includes the computer control module 110 depicted and described above with regard to FIG. 1. In some embodiments, the computer control module 110 may be responsible for determining whether an attempt to deliver a package or otherwise access either of the point-of-access receptacles 202-204 is authorized. Carrier personnel may scan the tracking code of a package being delivered in order to access either of the receptacles 202-204. In a manner substantially similar to the description provided above with reference to FIGS. 1A-B, the control module 110 arbitrates access to the receptacles 202-204 to ensure that only authorized deliveries are allowed. In other embodiments, an authorized person such as a postal carrier may gain access to either of the receptacles 202-204 to deliver a package in other ways such as through a traditional key-based lock.

In some embodiments of the present disclosure, the appropriate user is notified that a delivery directed to that specific user has been made at one of the receptacles 202-204. As described in further detail below, a network service provided by the present disclosure is utilized in authenticating carrier personnel and securing delivery of a package. As such, the network service may alert the appropriate user that a package has been delivered to one of the receptacles 202-204. By way of example only, aspects of the present disclosure may be configured to transmit a message to the appropriate user such as an email or SMS “text” message. The transmitted message may identify the package delivered and further include a unique Quick Response code (“QR code) or substantially similar “tracking code” that enables the user to access their delivered package from the appropriate receptacle. In order to access a package from the receptacle 202, the user may display the QR code on their mobile phone and cause it to be scanned at the tracking code scanner 212. In this regard, the computer control module 110 is responsible for determining whether this attempt to retrieve a delivered package is authorized. Access is granted to the specific user for whom a package has been delivered and secured by the receptacle 202. A user may be denied access in instances in which a scanned tracking code is invalid or not current. Accordingly, this aspect of the present disclosure differentiates between potentially multiple users and only grants access to one that is currently authorized based on whether they have an awaiting delivery.

The description provided above with reference to FIGS. 1A-2B includes exemplary embodiments of the present disclosure when implemented in both single user and multi-user scenarios. The description and illustrative embodiments shown utilize specific components in order to secure package deliveries. However, those skilled in the art and others will recognize that the present disclosure may be implemented in a number of different scenarios than those described and that substantially similar components may be utilized without departing from the scope of the claimed subject matter. Accordingly, the illustrative scenarios and components described above with reference to FIGS. 1A-2B should be construed as exemplary and not limiting.

Now with reference to FIG. 3, an exemplary architecture of the control module 110 previously mentioned with reference to FIGS. 1A-2B will be described in further detail. As shown, the control module 110 includes a processor 320 (e.g., a CPU), a memory 322A, a storage system 322B, a network communication unit 302, and a bus 326. The bus 326 provides a communications link between each of the components in the control module 110. In addition, the control module 110 includes a random-access memory (RAM), a read-only memory (ROM), and an operating system (O/S).

As illustrated in FIG. 3, the control module 110 includes the I/O interface 324 in communication with the I/O device 328. Generally described, the I/O interface 324 implements functionality that enables the exchange in information between internal storage and external I/O devices. By way of example, the I/O interface 324 of the present disclosure will exchange data with one or more tracking code scanners as described above with reference to FIGS. 1A-2B. These and other external devices communicate with the control module 110 utilizing the I/O interface 324. As further shown in FIG. 3, the control module 110 includes the power supply 304 which is a hardware component that supplies power to the control module 110. The power supply 304 receives power from the input power 305 and is configured to regulate the voltage to an appropriate amount, which enables the control module 110 to implement functionality without overheating. In this regard, aspects of the present disclosure may obtain input power 305 from any number of different power sources including, but not limited to an AC-based electrical outlet, a battery, and or any other type of power source capable or supplying the power supply 304 with sufficient electrical power.

The control module 110 illustrated in FIG. 3 further includes a network communication unit 302 for communicating with other devices or networks. In one embodiment, the communication unit 302 includes a wireless communication unit 303 that includes communication circuitry for permitting wireless communication over one or more of the IEEE 802.11 WiFi® networks. In an exemplary embodiment, a user may configure a point-of-access receptacle and control module 110 to connect to the users' local WiFi network and utilize the local network connection to perform Internet-based communications. However, the wireless communication unit 303 may be configured to connect to other types of networks than a WiFi network. In this regard, wireless communication unit 303 may be configured to communicate utilizing any number of different types of wireless network communication protocols such as, but not limited to, a WiFi® (IEEE 802.11) network, a cellular network (3G, 4G, 5G, GMS, CDMA, etc.), Bluetooth, or a home network (ZigBee, UWB, and the like). Regardless of the type of network and protocols used, the wireless communication unit 303 provides the transceiver/receiver circuitry for communicating wirelessly with other devices and/or networks. Moreover, the network communication unit 302 may be configured to support wired communications through, for example, an Ethernet connection. Regardless of the exact network or communication protocols used, the network communication unit 302 is configured for communicating data across the existing wireless and/or Internet-based infrastructure.

In the embodiment illustrated and discussed with reference to FIG. 3, the control module 110 further includes the reset button 308 and indicator lights 310. In this regard, activation of the reset button 308 causes the control module 110 to reboot. Moreover, the state of the control module 110 may be represented in the indicator lights 310 which may provide feedback regarding boot status, the availability of power or state of the power supply 304, among others. In this regard, the information represented in the indicator lights 310 may be used to provide basic feedback which can be especially useful in troubleshooting any issues with the control module 110. While FIG. 3 illustrates a control module 110 having specific components for providing boot and status information, one skilled in the art and others will recognize that the control module 110 may have additional or fewer components and/or different components without departing from the scope of the claimed subject matter. The processor 320 executes computer program code (e.g., program control 344), which can be stored in the memory 322A and/or storage system 322B. In embodiments, the program control 344 of the control module 110 provides an application 350, which comprises program code that is adapted to perform one or more of the processes described herein. The application 350 can be implemented as one or more program code in the program control 344 stored in memory 322A as separate or combined modules. Additionally, the application 350 may be implemented as separate dedicated processors or a single or several processors to provide the functions described herein. While executing the computer program code, the processor 320 can read and/or write data to/from memory 322A, storage system 322B, the network communication unit 302, and/or the I/O interface 324. In this manner, the program code executes the processes of the present disclosure. The program code can include computer program instructions that are stored in a computer-readable storage medium. The computer program instructions may also be loaded onto a computing device, other programmable data processing apparatus, or other devices to cause a series of operational steps to be performed on the control module 110. Moreover, any methods provided herein in the form of flowcharts, block diagrams or otherwise may be implemented using the computer program instructions, implemented on the computer-readable storage medium. The computer-readable storage medium comprises any non-transitory medium per se, for example, such as electronic, magnetic, optical, electromagnetic, infrared, and/or semiconductor system. More specific examples (a non-exhaustive list) of the computer-readable storage medium include: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any combination thereof. Accordingly, the computer-readable storage medium may be any tangible medium that can contain or store a program for use by or in connection with an instruction execution system, apparatus, or device of the present invention.

One skilled in the art will recognize that the control module 110 depicted in FIG. 3 may have more or further components than those depicted without departing from the scope of the claimed subject matter. In addition, components may be arranged or connected utilizing a different computing device architecture than shown or described in FIG. 3 without departing from the scope of the claimed subject matter. Accordingly, the architecture described and shown with reference to FIG. 3 should be construed as exemplary and not limiting.

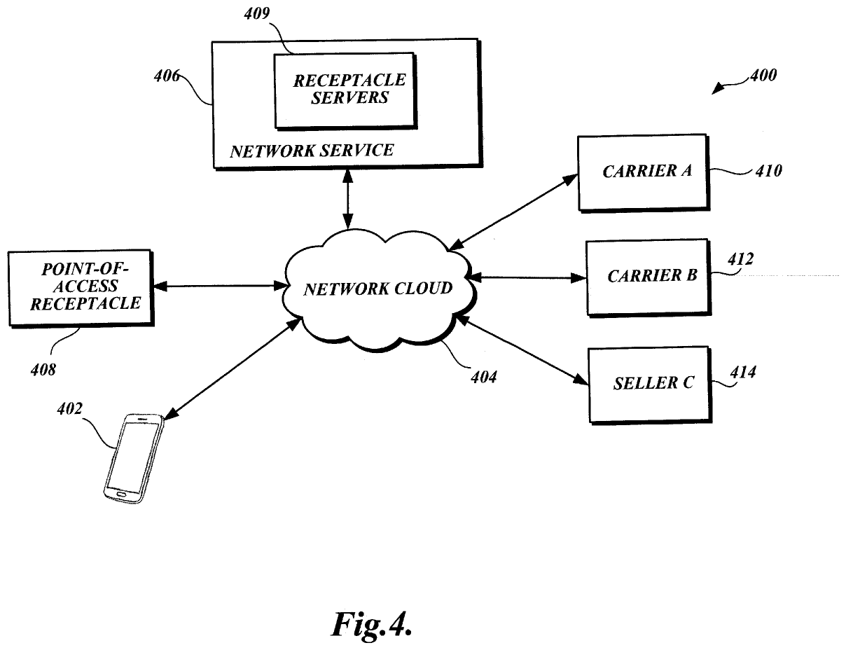

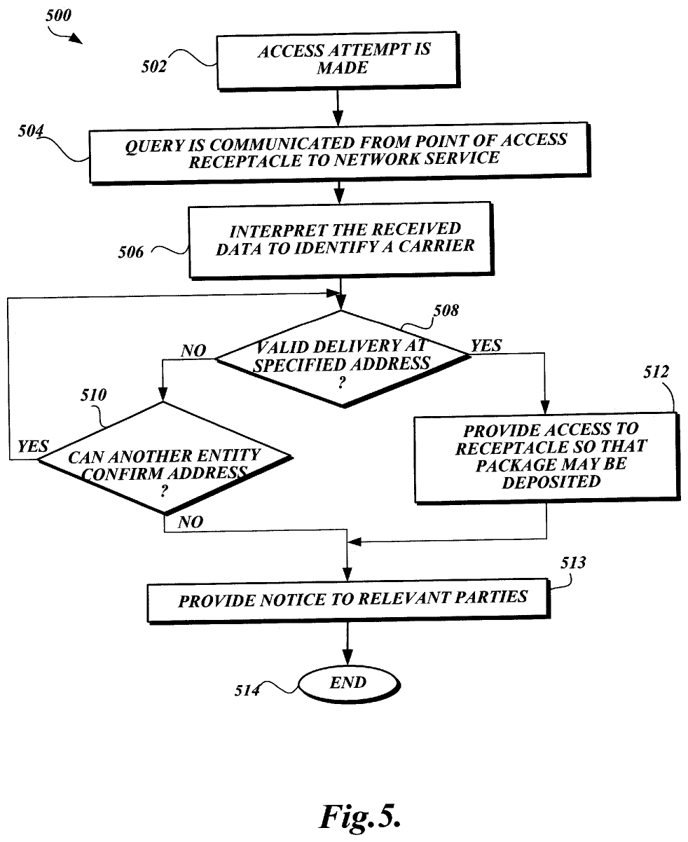

Now with reference to FIG. 4 an exemplary networking environment 400 in which aspects of the present disclosure may be implemented will be described. As shown in FIG. 4, the networking environment 400 includes the point-of-access receptacle 408 communicatively connected to a user device 402 through a network cloud 404 (e.g., the Internet). In this regard, the user device 402 can be a mobile device (smart phone or tablet), desktop computer, or any other similar device capable of executing an “app” provided by the present disclosure or a Web browser and perform communications via the network cloud 404. As described in further detail below with reference to FIG. 5, the user device 402 may be employed to implement a process in setting up the point-of-access receptacle 408. In one embodiment, the user device 402 is connected directly to the network cloud 404 and can communicate with any network devices including the point-of-access 408 receptacle and receptacle servers 409 over an Internet connection. In this instance, setup information may be communicated directly between the user device 402 and the receptacle servers 409. In another embodiment, the user device 402 connects directly to an associated point-of-access receptacle 408 using, for example, a direct WiFi or Bluetooth connection. To communicate setup or other information to the receptacle servers 409, in this instance, the user device 402 first communicates this information to the point-of access receptacle 408 for forwarding to the receptacle servers 409. More generally, the user device 402 may participate in communications with the receptacle servers 409 leveraging the network connection of the point-of-access receptacle 408 in some embodiments of the present disclosure.

As further shown in FIG. 4, the networking environment 400 includes the network service 406 communicatively connected to other devices via the network cloud 404. In one aspect, the network service 406 provided by the present disclosure is configured to manage the delivery of packages through the confirmation of delivery information relative to a user's scheduled purchases/deliveries. The network service 406 is configured to receive and store setup information associated with specific users and their point-of-access receptacles. This type of information may include, but is not limited to a user's name, address, an identification number associated with the user's specific point-of-access receptacle (hereinafter “receptacle identifier”), among others. At time of package delivery, the network service 406 is responsible for determining whether access should be granted to a particular point-of-access receptacle, in accordance with one embodiment of the present invention. Specifically, carrier personnel may scan a tracking code of a package being delivered at the point-of-access receptacle. From the scanned tracking code information, package identifying information may be derived and communicated across the network cloud 404 to the network service 406 which may include the tracking number, receptacle identifier, and/or other information associated with the scanned package. Significantly, aspects of the present disclosure may use the tracking number associated with a package as a key to uniquely identify a delivery. One skilled in the art will recognize that using the tracking number in this way provides for a more secure system where the unique identifier associated with a delivery is not generated by either the seller or package recipient. As further illustrated in FIG. 4, the functionality of the network service 406 as described herein may be carried out by the receptacle servers 409 which are connected to the network cloud 404 and therefore able to communicate with other devices connected to the network cloud 404, as appropriate.

As further illustrated in FIG. 4, the network environment 400 depicted in this exemplary embodiment includes CARRIER A 410, CARRIER B 412, and SELLER C 414 also connected to the network cloud 404. In determining whether an attempted package delivery is authorized, the receptacle servers 409 may issue one or more network queries to the appropriate carrier (e.g., CARRIER A 410, CARRIER B 412, and the like), seller (e.g., SELLER C 414) and/or other network connected entities to obtain information that describes or otherwise identifies the user's scheduled or bona-fide deliveries. As a result, a determination may then be made by the network service 406 as to whether an attempted access of the particular point-of-access receptacle is valid and should be granted. The architecture of the receptacle servers 409 or user device 402 depicted in FIG. 4 will typically utilize a standard computer architecture which may be resident on the network cloud 404 and communicate with other network-connected computing devices.

In another embodiment, a package may be sent by a user employing the point-of-access receptacle 408 provided by the present invention to secure the package. An item may need to be returned to an eCommerce provider, for example, with carrier personnel being authenticated at the point-of-access receptacle 408 at the time of pickup. In an exemplary embodiment, the user may initiate the return through interactions with a Web site, application, and the like. For example, eCommerce sites enable users to initiate a return from an online account which typically includes creation of an appropriate shipping label. Then, the package may be deposited and secured by the user in the point-of-access receptacle 408 for delivery back to the appropriate seller or other entity. At the time of pickup, a security credential provided by carrier personal is scanned at the tracking code scanner 104 and authenticated. In this way, aspects of the present invention can also secure the delivery of packages or returns from a user back to a seller or other entity.

Now with reference to FIG. 5, an authentication method 500 will be described that is configured to determine whether an attempted delivery at a point-of-access receptacle is valid. In one embodiment, a setup process is implemented prior to executing the method 500 that configures a user's point-of-access receptacle and enables the secure delivery of packages from potentially multiple carriers and/or sellers. At time of installation or otherwise, a user may provide configuration information in setting up their point-of-access receptable. In one aspect, the present disclosure provides an application that executes on a user's computing device (e.g., user device 402). In this regard, the setup process implemented by the application provided by the present disclosure may include setting up an account with a network service provided by the present disclosure (e.g., network service 406) in which a token of user-specific information is provided. The token of user specific information may include, but is not limited to, user name, address, telephone number, WiFi credentials, email address, and/or a receptacle identifier associated with the specific point-of-access receptacle that is being installed at a user's residence/business. In addition, a user's security credentials for one or more carriers may be obtained. For example, the setup process implemented by the present invention may be configured to obtain a username and password associated with each of a user's Amazon Prime, FedEx, United Parcel Service, USPS, and similar accounts. However, obtaining a user's account credentials with one or more carriers may not be performed in all embodiments of the present invention. Once setup is complete, none of the parties involved in a transaction (e.g., seller, carrier company, or user) need to take different actions in undertaking a transaction. A user may make a purchase from an eCommerce website without having to provide any additional information than is normally provided. The seller ships the package to the address associated with the user without having to change their existing processes. A carrier undertakes delivery as would normally occur with the only difference being that a package is scanned and deposited in the point-of-access receptacle once it has been authorized. Now with reference to FIG. 5, a method 500 that authenticates bona-fide deliveries and enables secure access to a receptacle provided by the president disclosure will be described.

As illustrated in FIG. 5, the authorization method 500 begins at block 502 where an attempt is made to access a receptacle provided by the present disclosure. In particular and as described above, carrier personnel may initiate a delivery attempt by scanning a tracking code associated with the package. The receptacle 100 provided by the present disclosure includes a tracking code scanner 104 that is able to read a printed tracking code, decode the tracking code data and transmit the data to a communicatively connected computing device (e.g., the control module 110) at block 502. Significantly, the data obtained when a package is scanned includes at least the tracking number associated with the package.

At block 504 of the authorization method 500, a network query is communicated between the point-of-access receptacle and the network service 406 provided by the present invention. In one embodiment, the network query effectively serves as a request to determine whether a particular package whose tracking code was scanned at block 502 is actually a package that is scheduled to be delivered to a user's address. In this regard, the query that is transmitted to the network service 406, at block 504, typically includes a set of information that may be used to determine whether an attempted access of a point-of-access receptacle at an associated address is bona-fide. This set of information typically includes a tracking number derived from the tracking code scanned at block 502 and the corresponding receptacle identifier.

At block 506 of the authentication method 500 aspects of the present disclosure interprets the data received from the point-of-access receptacle at block 504 to identify the carrier and/or other entity associated with the package scanned at block 502. In accordance with existing systems, a tracking number is a value assigned to a package when shipped that serves as a unique ID number or code. The tracking number itself consists of letters and numbers typically between 8 and 40 characters long sometimes with spaces or hyphens between groupings of characters. Significantly, different tracking number formats are typically utilized that are specific to particular carriers. By way of example, United Parcel Service packages within the United States generally start with the characters “1Z” followed by a six (6) character shipper number, a two (2) digit service level indicator and then an eight (8) digit package identifier for a total of eighteen characters. One skilled in the art and others will recognize that other carriers (FedEx, Amazon.com, USPS, etc.) utilize similarly distinctive characteristics in their tracking numbers that enables differentiation between carriers based on tracking number format. Accordingly, processing is performed on the tracking number (obtained at block 502) to identify the specific carrier and/or other entity that is associated with the tracking number. This processing performed at block 506 generally includes analyzing the format of a string of characters to identify characteristics that are known to be specific to a particular carrier.

At decision block 508 a determination is made regarding whether an attempt to access the point-of-access receptacle at a specific address is a valid delivery from an authorized carrier, seller, or other entity. In one embodiment, a network query is generated from the receptacle servers 409 provided by the present disclosure. The query may be communicated to the appropriate carrier for the purpose of determining whether the package is scheduled to be delivered at the address associated with a particular point-of-access receptacle. For example, if a package is scanned that has a tracking number associated with UPS, a network query may be generated and communicated, at block 508, in order to determine whether UPS is actually scheduled to deliver a package to an address associated with this specific point-of-access receptacle.

As mentioned above and in accordance with some embodiments of the present invention, a carrier, seller, or other entity may expose an Application Programming Interface (APIs) that can be queried by the network service and methods provided by the present disclosure. The relevant APIs expose procedures that may be used to determine what, if any, deliveries are scheduled for a specific user and address. In some embodiments, making the determination regarding whether a bona-fide package is being delivered is performed by querying a carrier, seller, or other entity for an address associated with a particular tracking number or shipment. In response, the carrier or seller may respond with information that identifies an address associated with the shipment. The delivery may be identified as being authentic if the shipping address provided by a carrier or seller matches the address associated with the user's specific point-of-access receptacle. The receptacle servers 409 (FIG. 4) provided by the present disclosure obtains this information and determines whether the addresses are a match, at block 508. In other embodiments, the method 500 queries a carrier or seller and provides a set of verification information that includes a tracking number and/or address of the shipment. The carrier or seller may then determine whether the shipment is valid and respond with a binary indicator as to whether a particular delivery attempt is bona-fide. In this regard, one skilled in the art and others will recognize that the exact manner in which information for verifying the validity of a delivery is obtained by the present disclosure may be carrier and/or seller dependent and may therefore be done in any number of different ways and the examples provided herein should be construed as exemplary.

As mentioned above and in accordance with additional embodiments of the present invention, a user's security credentials for one or more carriers may be obtained at account setup or otherwise. In these embodiments, making the determination regarding whether a bona-fide package is being delivered, at block 508, may be performed by accessing a user's online account. For example, Amazon.com accounts include a detailed history of all of a user's purchases and may be accessed to determine whether a particular delivery attempt is bona-fide, at block 508. However, obtaining a user's account credentials with one or more carriers and/or sellers may not be performed in all embodiments of the present invention.

In the event that the determination made at block 508 is “NO” and a delivery attempt is not confirmed by a specific carrier as being bona-fide, then the authentication method 500 proceeds to decision block 510. At decision block 510, a determination is made regarding whether another entity involved in a transaction should be queried to authenticate the access attempt. In this regard, modern supply and delivery chains can be complicated and usually involve a number of different parties (sellers, carriers, buyers, etc.). For example, a user may purchase a product on Amazon.com that would typically by delivered directly by the eCommerce provider. However, Amazon.com may outsource some of their deliveries to FedEx or other carrier. Accordingly, aspects of the present disclosure provides a robust framework capable of handling complex eCommerce deliveries that involve a number of entities. In one embodiment, potentially multiple entities involved in a transaction are queried to confirm a shipping address and authenticate a delivery. In the example above, a query may be sent first to the primary carrier, namely FedEx, at block 508 to authenticate the delivery. Of course, a determination may be made that an attempted access is completely invalid in which case another entity involved in the transaction may not be queried. This may occur when the shipping address of the scanned package does not match the shipping address of the user's point-of-access receptacle. But the query could fail for reasons unrelated to the legitimacy of an attempted package delivery. The primary carrier's (e.g., FedEx) web services could be temporarily unavailable, for example. However, the present disclosure is configured to query multiple entities involved in the transaction in certain situations in an attempt to authenticate the delivery. As such, another entity involved in the transaction (e.g., Amazon.com) may then be queried to confirm the shipping address of the package. As illustrated in FIG. 5, at decision block 510 of the authentication method 500 a determination is made regarding whether another entity should be queried to authenticate an attempted delivery. If the delivery can be authenticated by another entity and the result of the test performed at block 510 is “YES”, then the authentication method 500 proceeds back to block 508 and blocks 508-510 repeat until all the entities that can authenticate the delivery have been queried or the package delivery is authenticated. In the event that the authentication attempt has been identified as being invalid or all the entities have been queried, then the authentication attempt fails and the method 500 proceeds to block 513, described in further detail below.

If a determination made at block 508 is “YES” and a delivery attempt is bona-fide, then the authentication method 500 proceeds to block 512 where access to the receptacle is granted. The systems and methods for granting access to the receptacle are described above with reference to FIGS. 1A-3 and will not be repeated here. Once the delivery has been completed, the control module 110 implements logic for activating the locks 108, 208, 210 and securing the receptacles 102, 202, and 204, respectively. In this way, the present disclosure secures a delivered package and prevents any attempts of “porch piracy.”

At block 513 of the exemplary authentication method 500 depicted in FIG. 5, the appropriate notice is provided to the parties involved in a package delivery. In instances when a package delivery was completed, the sender and recipient will generally be notified through electronic communication, (email, SMS message, etc.), that a package was successfully delivered. If FedEx made a successful delivery, for example, the recipient may receive a text message saying “You're have a new package” in the users' delivery box. Similarly, FedEx may receive a push notification regarding the successful delivery. In instances when a delivery attempt fails, the relevant parties are also notified of the unsuccessful delivery attempt, at block 513. In most instances, the relevant parties are provided with a contextually relevant notice regarding why a delivery attempt failed. For example, carrier personnel could attempt delivery of a valid package to the wrong address. In this example, the carrier may be provided with notice as to reason for the failed delivery so that corrective action may be taken. In any event, the relevant parties may be provided with contextually relevant information regarding a delivery attempt. Then, the authentication method 500 proceeds to block 514 where it terminates.

While the preferred embodiments of the present disclosure have been illustrated and described, it will be appreciated that various changes can be made therein without departing from the spirit and scope of the disclosed subject matter.

The embodiments of the disclosure in which an exclusive property or privilege is claimed are defined as follows:

1. A control module for arbitrating access to a receptacle, the control module comprising:
a processor operable to execute computer program code;
a network communication unit operable to communicate with remote devices over a network;
a memory operable to store data and provide the computer program code to the processor for execution, the memory including an application configured to:
derive a tracking number from a scanned tracking code, identify a carrier associated with the identified tracking number, and cause the network communication unit to submit a network query to confirm the validity of an attempted access of the receptacle; and
wherein the application is further configured to receive a response to the submitted network query, determine whether the attempted access of the receptacle is valid, and if a determination is made that the attempted access of the receptacle is valid, provide carrier personnel with access to the receptacle.

2. The control module as recited in claim 1, wherein to determine whether the attempted access of the receptacle is valid includes differentiating between deliveries sent to different users who share a common receptacle and notifying a specific user that the user received a delivery.

3. The control module as recited in claim 2, wherein the control module is further configured to provide a recipient of the delivered package with access to the receptacle in response to receiving a scanned tracking code associated with the delivered package.

4. The control module as recited in claim 1, wherein the network communication unit is further configured to connect to a local WiFi network and utilize the local WiFi network connection to perform Internet-based communications with a network service.

5. The control module as recited in claim 1, wherein to determine whether the attempted access of the receptacle is valid includes determining whether the carrier associated with the identified tracking number is scheduled to deliver the package to the user.

6. The control module as recited in claim 1, wherein to provide carrier personnel with access to the receptacle includes actuating a lock to the open position.

7. A method for determining whether an attempt to access a receptacle associated with a user is authorized, comprising:
receiving a request to access the receptacle;
identifying a tracking number associated with a package in transport;
identifying a carrier associated with the identified tracking number;
accessing a network service to determine whether the carrier associated with the identified tracking number is scheduled to deliver the package to an address associated to the receptacle; and
if a determination is made that the carrier is scheduled to deliver the package to the specified address, providing carrier personnel with access to the receptacle.

8. The method as recited in claim 7, further comprising if a determination is made that the carrier associated with the identified tracking number is not scheduled to deliver the package to the specified address, preventing access to the receptacle and notifying the user of an unauthorized attempt to access the receptacle.

9. The method as recited in claim 7, further comprising:
sending notice to the user regarding the delivery, the notice including a tracking code for accessing the receptacle;
receiving the scanned tracking code from the user; and
providing the user with access to the receptacle.

10. The method as recited in claim 7, wherein determining whether an attempt to access a receptacle associated with a user includes obtaining a token of setup information from the user that identifies at least an address where packages are delivered to the user.

11. The method as recited in claim 7, wherein carrier personnel attempt to access the receptacle by scanning a QR code printed on the package and wherein receiving a request to access the receptacle includes receiving the scanned QR code.

12. The method as recited in claim 7, wherein identifying a carrier associated with the identified tracking number includes analyzing a string of characters derived from a QR code to identify string characteristics that are specific to a particular carrier.

13. The method as recited in claim 7, wherein accessing a network service to determine whether the carrier is scheduled to transport the package includes issuing a network call to an Application Programming Interface provided by the carrier.

14. The method as recited in claim 7, wherein accessing a network service to determine whether the carrier is scheduled to transport the package includes obtaining the user's account credentials with the carrier and accessing a user's online account using the obtained account credentials.

15. The method as recited in claim 7, further comprising authenticating a security credential associated with a package being shipped from the point-of-access receptacle.

16. A network service operable to determine whether an attempted access of a receptacle associated with a user is authorized, the network service configured to:
obtain a token of setup information from the user that identifies at least an address where packages are delivered to the user;
receive a request to determine whether an attempted access of the receptacle associated with the user is authorized, the request including at least a tracking number associated with a package;
identify a carrier associated with the identified tracking number;
obtain delivery information from a network system provided by the carrier; and
use the obtained delivery information to determine whether the carrier is scheduled to deliver a package to an address associated with the user.

17. The network service as recited in claim 16, wherein the network service is in communication with an application executing on a computing device associated with the user and wherein the user inputs the token of setup information that identifies at least an address where packages are delivered from said application.

18. The network service as recited in claim 16, wherein to obtain delivery information from a network system provided by the carrier includes issuing a network call to an Application Programming Interface provided by the carrier.

19. The network service as recited in claim 16, wherein to obtain delivery information from a network system provided by the carrier includes obtaining the user's account credentials and accessing the user's online account with the carrier using the obtained account credentials.

20. The network service as recited in claim 16, wherein the network service is further configured to authenticate carrier personnel and provide access to the point-of-access receptacle for a package being shipped from the user.
